(19) United States
(12) Patent Application Publication
(10) Pub. No.: US 2020/0319635 A1
(43) Pub. Date: Oct. 8, 2020

(54) SEMI-AUTONOMOUS VEHICLE DRIVING SYSTEM, AND METHOD OF OPERATING SEMI-AUTONOMOUS VEHICLE

(71) Applicant: INTERNATIONAL BUSINESS MACHINES CORPORATION, ARMONK, NY (US)

(72) Inventors: JOSH ANDRES, MELBOURNE (AU); JOHN WAGNER, CARLTON (AU); TIMOTHY M. LYNAR, MELBOURNE (AU); WENBIN ZHANG, SINGAPORE (CN)

(21) Appl. No.: 16/375,275

(22) Filed: Apr. 4, 2019

(51) Int. Cl. G05D 1/00; G05D 1/02

(52) U.S. Cl. CPC G05D 1/0061; G05D 2201/0213; G05D 1/0212; G05D 1/0088

(57) ABSTRACT

A method of operating a semi-autonomous vehicle includes receiving a target destination, determining one or more routes from a current location to the target destination, determining a forecasted risk associated with the one or more routes, and predicting a latest point in time at which control of the vehicle should be handed over from the vehicle to the driver based on the forecasted risk. The method further includes calculating an amount of time needed to enable the driver to safely take over control of the vehicle by the latest point in time, calculating a handover time at which control of the vehicle is to be handed off from the vehicle to the driver based on the latest point in time and the calculated amount of time, and providing a takeover alert to the driver at the handover time indicating that the driver should take over control of the vehicle.

### BACKGROUND

The present invention relates to semi-autonomous vehicles, and more specifically, to handing over control from a semi-autonomous vehicle to a driver of the semi-autonomous vehicle.

A semi-autonomous vehicle, which is in the process of autonomously driving itself, may hand over control of the driving to the driver when a situation that requires the driver's awareness and/or input arises. However, handing over control to the driver when the vehicle is already in a complex situation or too close to a complex situation may result in a lack of context for the driver, which can increase risk and decrease safety.

### SUMMARY

According to an exemplary embodiment, a method of operating a semi-autonomous vehicle includes receiving a target destination of the semi-autonomous vehicle. The method further includes determining, by at least one processor, one or more routes from a current location of the semi-autonomous vehicle to the target destination. The method further includes determining, by the at least one processor, a forecasted risk associated with each of the one or more routes. The method further includes predicting, by the at least one processor, a latest point in time at which control of the semi-autonomous vehicle should be handed over from the semi-autonomous vehicle to a driver of the semi-autonomous vehicle based on the forecasted risk. The method further includes calculating, by the at least one processor, an amount of time needed to enable the driver to safely take over control of the semi-autonomous vehicle by the latest point in time. The method further includes calculating, by the at least one processor, a handover time at which control of the semi-autonomous vehicle is to be handed off from the semi-autonomous vehicle to the driver based on the latest point in time and the calculated amount of time. The method further includes providing a takeover alert to the driver at the handover time indicating that the driver should take over control of the semi-autonomous vehicle.

According to an exemplary embodiment, a semi-autonomous vehicle system includes a memory storing a computer program, and a processor that executes the computer program. The computer program is configured to receive a target destination of a semi-autonomous vehicle, determine one or more routes from a current location of the semi-autonomous vehicle to the target destination, determine a forecasted risk associated with each of the one or more routes, and predict a latest point in time at which control of the semi-autonomous vehicle should be handed over from the semi-autonomous vehicle to a driver of the semi-autonomous vehicle based on the forecasted risk. The computer program is further configured to calculate an amount of time needed to enable the driver to safely take over control of the semi-autonomous vehicle by the latest point in time, calculate a handover time at which control of the semi-autonomous vehicle is to be handed off from the semi-autonomous vehicle to the driver based on the latest point in time and the calculated amount of time, and provide a takeover alert to the driver at the handover time indicating that the driver should take over control of the semi-autonomous vehicle.

According to an exemplary embodiment, a computer program product includes a computer readable storage medium having program instructions embodied therewith. The program instructions are executable by a processor to cause the processor to receive a target destination of a semi-autonomous vehicle, determine one or more routes from a current location of the semi-autonomous vehicle to the target destination, determine a forecasted risk associated with each of the one or more routes, and predict a latest point in time at which control of the semi-autonomous vehicle should be handed over from the semi-autonomous vehicle to a driver of the semi-autonomous vehicle based on the forecasted risk. The program instructions executable by the processor further cause the processor to calculate an amount of time needed to enable the driver to safely take over control of the semi-autonomous vehicle by the latest point in time, calculate a handover time at which control of the semi-autonomous vehicle is to be handed off from the semi-autonomous vehicle to the driver based on the latest point in time and the calculated amount of time, and provide a takeover alert to the driver at the handover time indicating that the driver should take over control of the semi-autonomous vehicle.

### BRIEF DESCRIPTION OF THE DRAWINGS

The above and other features of the present invention will become more apparent by describing in detail exemplary embodiments thereof with reference to the accompanying drawings, in which:

FIG. 1 is a block diagram of a semi-autonomous vehicle driving system according to an exemplary embodiment of the present invention.

FIG. 2 is a flowchart illustrating a method of operating a semi-autonomous vehicle according to exemplary embodiments of the present invention.

FIG. 3 is a flowchart illustrating a method of calculating an amount of time needed to enable a driver to safely take over control of a semi-autonomous vehicle by a critical time point according to an exemplary embodiment of the present invention.

FIG. 4 is a flowchart illustrating a method of calculating an amount of time needed to enable a driver to safely take over control of a semi-autonomous vehicle by a critical time point according to an exemplary embodiment of the present invention.

FIG. 5 is a block diagram of a computer system that may be used to implement various aspects of exemplary embodiments of the present invention.

### DETAILED DESCRIPTION

Exemplary embodiments of the present invention will be described more fully hereinafter with reference to the accompanying drawings. Like reference numerals may refer to like elements throughout the accompanying drawings.

Exemplary embodiments of the present invention provide an improved semi-autonomous vehicle driving system that decreases the level of risk associated with the semi-autonomous vehicle autonomously driving itself, thus, improving safety. For example, a conventional semi-autonomous vehicle driving system may recognize a situation in which driving of the semi-autonomous vehicle should be handed over from the semi-autonomous vehicle to the driver. However, a conventional semi-autonomous vehicle typically hands over control to the driver when the vehicle is already in a complex/dangerous situation or too close to a complex/dangerous situation. As a result, the driver may not be given enough time to gain context and prepare for the complex/dangerous situation, resulting in increased risk and decreased safety. Exemplary embodiments of the present invention solve this problem by intelligently and dynamically determining an appropriate time before arriving at a complex/dangerous situation at which to alert the driver that the complex/dangerous situation is upcoming, thus, affording the driver enough time to prepare for the complex/dangerous situation, thereby decreasing risk of an accident and improving safety.

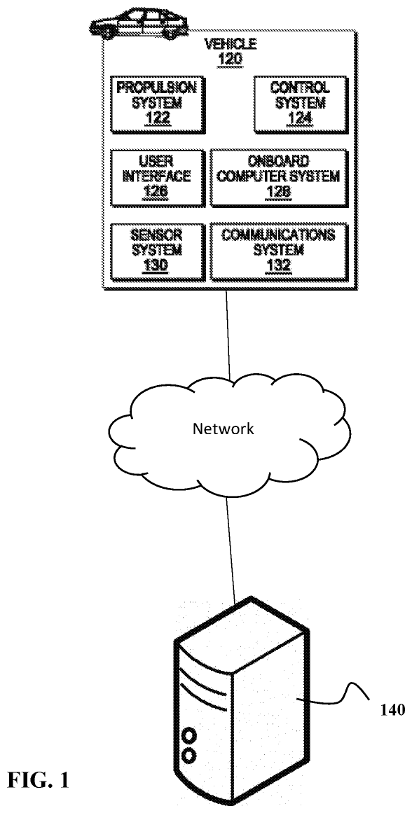

FIG. 1 is a block diagram of a semi-autonomous vehicle driving system according to an exemplary embodiment of the present invention.

Referring to FIG. 1, a semi-autonomous vehicle 120 includes a propulsion system 122, a control system 124, a user interface 126, an onboard computer system 128, a sensor system 130 and a communications system 132. The semi-autonomous vehicle 120 is a motorized vehicle that is driven under control of both the semi-autonomous vehicle and a driver. The semi-autonomous vehicle 120 may be in communication with a server computer 160 via a network 140.

The propulsion system 122 includes components operable to provide powered motion to the semi-autonomous vehicle 120. In exemplary embodiments, the propulsion system 122 may include, for example, an engine/motor, an energy source, a transmission, and/or wheels/tires. The engine/motor can be any combination of, for example, an internal combustion engine, an electric motor, a steam engine, a Stirling engine, or other types of engines/motors. In exemplary embodiments, the propulsion system 122 may include multiple types of engines and/or motors such as, for example, a gas-electric hybrid car. The energy source can be, for example, gasoline, diesel, other petroleum-based fuels, propane, other compressed gas-based fuels, ethanol, solar panels, and/or batteries. In exemplary embodiments, the transmission can include a gearbox, clutch, differential, and drive shafts.

The control system 124 is a collection of mechanical, electro-mechanical, and electronic systems that can be configured to control the operations of the semi-autonomous vehicle 120. In exemplary embodiments, the control system 124 may include a steering unit, a throttle, a brake unit, and/or a navigation system. In exemplary embodiments, the steering unit can be a mechanism that can control the heading and/or turning of the semi-autonomous vehicle 120. In exemplary embodiments, the throttle can be configured to control the operating speed of the engine/motor and, in turn, the speed of the semi-autonomous vehicle 120. In exemplary embodiments, the brake unit can include any combination of mechanisms configured to decelerate the semi-autonomous vehicle 120. The brake unit can use, for example, friction to slow the rotation of the tires/wheels. In exemplary embodiments, the brake unit converts kinetic energy of the wheels/tires into electrical current. In exemplary embodiments, the navigation system can be any system configured to determine a driving path for the semi-autonomous vehicle 120. In exemplary embodiments, the navigation system receives input information from the GPS and camera systems included in the sensor system 130 to generate the driving path for the semi-autonomous vehicle 120.

The user interface 126 is a mechanism by which the driver and passengers in the semi-autonomous vehicle 120 can interact with the semi-autonomous vehicle 120. The user interface 126 can include buttons, knobs, levers, pedals, paddles, and/or any other type of user interface, such as a touchscreen display capable of detecting the location and/or movement of a user's finger. The touchscreen can be, for example, a capacitive sensing screen, a resistance sensing screen, or a surface acoustic wave sensing screen. The user interface 126 may further include an alert system that provides alerts to the driver, as described in further detail below.

The onboard computer system 128 is a computing system including at least one computer processor that is capable of controlling one or more functions of the semi-autonomous vehicle 120 based on inputs received from one or more of the systems included in the semi-autonomous vehicle 120. For example, in an exemplary embodiment, the onboard computer system 128 can control the propulsion system 122 based on information received from the sensor system 130, information received via the control system 124 and/or information received via the communications system 132. The onboard computer system 128 may further include a memory that stores program instructions that are executed by the at least one computer processor, and a database that stores collected data.

The sensor system 130 may include any number of sensors configured to detect information about the semi-autonomous vehicle 120 and its surrounding environment. In exemplary embodiments, the sensor system 130 may include a global positioning system (GPS), an inertial measurement unit (IMU), a RADAR unit, a LIDAR unit, and/or a camera. The GPS can be any sensor configured to estimate a geographic location. The IMU can be any combination of sensors configured to sense position and orientation changes in the semi-autonomous vehicle 120 based on inertial acceleration. The RADAR unit can be any system that uses radio signals to sense objects within the local environment of the semi-autonomous vehicle 120. In exemplary embodiments, the RADAR unit can also detect relative motion between the semi-autonomous vehicle 120 and the semi-autonomous vehicle's 120 surroundings. The LIDAR unit can be any system configured to sense objects in the semi-autonomous vehicle's 120 environment using one or more lasers. The camera can include one or more devices configured to capture a plurality of images of the environment of the semi-autonomous vehicle 120. The camera can be a still or a video camera and may record visible and/or infrared light. In an exemplary embodiment, the sensor system 130 may include a camera disposed inside the semi-autonomous vehicle 120 that monitors an awareness of the driver, as described in further detail below.

The communications system 132 can be any system configured to communicate with one or more devices directly or via network. In exemplary embodiments, the communications system 132 can include a transmitter and a receiver for sending and receiving electromagnetic waves, respectively, such as an antenna.

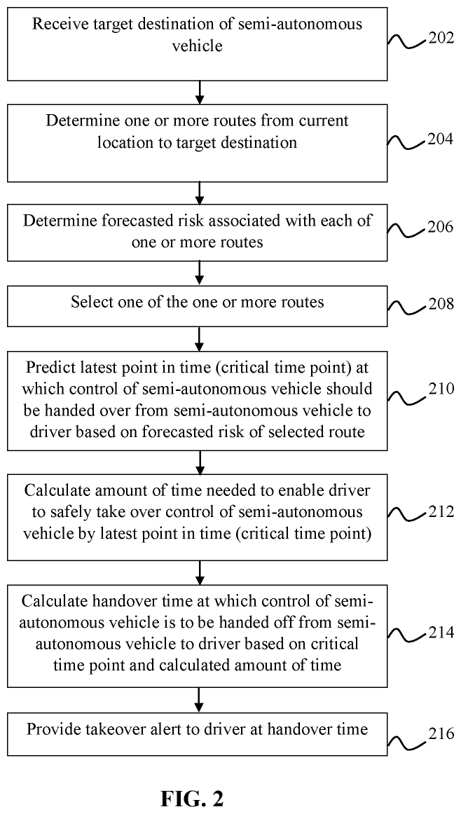

FIG. 2 is a flowchart illustrating a method of operating a semi-autonomous vehicle according to exemplary embodiments of the present invention.

Referring to FIGS. 1 and 2, in an exemplary embodiment, a target destination of the semi-autonomous vehicle 120 is received at operation 202. The target destination may be received by, for example, the driver or a passenger of the semi-autonomous vehicle 120. For example, the driver or a passenger of the semi-autonomous vehicle 120 may input the target destination via the user interface 126.

In operation 204, one or more routes from the semi-autonomous vehicle's 120 current location to the target destination are determined. For example, the one or more routes may be determined by the navigation system included in the control system 124. In exemplary embodiments, the one or more routes determined in operation 204 correspond to the fastest routes and/or the routes in which the least amount of distance is traveled.

In operation 206, a forecasted risk associated with each of the one or more routes identified in operation 204 is determined. For example, in exemplary embodiments, driving related data may be collected from a variety of driving data sources and amalgamated into a database (e.g., a database of the onboard computer system 128 in the semi-autonomous vehicle 120 or a remote database included in the server computer 160 and accessible to the semi-autonomous vehicle 120 via the communications system 132) for subsequent processing into an estimation of driving risk. A risk determination system may use driving data stored in the database to determine the existence of a predicted risk of an adverse event (e.g., any event leading to vehicle damage, injury to human occupants or loss of or damage to vehicle cargo). For example, the risk determination system may make reference to learning examples stored in a cognitive learning system to identify the existence of a predicted risk of an adverse event.

The driving data sources may include vehicle related sources of a plurality of vehicles that are in communication with the database. For example, vehicle sensors may measure or record vehicle performance, location, speed, driving patterns, driving decisions, driving quality, etc., of other vehicles that have traveled on or are traveling on each of the one or more routes identified in operation 204.

The driving data sources may further include driver related sources. For example, driver sensors worn by drivers of other vehicles that have traveled on or are traveling on each of the one or more routes may be able to detect driver parameters including physical driver parameters such as, for example, heart rate. Other driver data sensors, worn or otherwise, may be able to measure or estimate cognitive function, emotional states, etc.

The driving data sources may further include other environmental data sources that contribute data related to the driving environment of the one or more routes. Environmental data may include weather related data, road and traffic related data, accident or roadworks related data, etc. Such environmental data sources may be supplied by a third party provider.

Each data source may be configured and programmed to contribute data to the database, and may be used by the risk determination system to forecast risk associated with each of the one or more routes.

The risk determination system processes information for the purpose of computing and forecasting a risk profile of each of the one or more routes through the assessment of risk factors pertaining to driving and traffic data. Through the compiling of a sequence of states that are predictive of an elevated driving risk of an adverse event, a set of driving data predictors, as determined for example by the cognitive learning system, are used to estimate an elevated driving risk endangering a driver, vehicle's occupants or cargo. Having predicted the existence of an elevated risk level, a latest point in time at which control of the semi-autonomous vehicle 120 should be handed over from the semi-autonomous vehicle 120 to the driver may be predicted, as described in further detail below with reference to operation 210.

Herein, when it is described that the driver takes over control of the semi-autonomous vehicle 120, it is understood that this refers to the stopping of the semi-autonomous vehicle 120 autonomously driving itself and the starting of the driver manually driving the semi-autonomous vehicle 120.

The risk determination system may make use of the cognitive learning system. Driver states (e.g., states of drivers driving on the one or more routes) may be categorized using unsupervised learning from driver data, including video data and personal devices. The data is collected and analyzed into driver states. The states are further analyzed using supervised learning to determine the sequences of driver states that predict an accident event and/or a driver injury event.

By way of example, a vehicle undergoing frequent lane changes at a particular speed in a particular density of traffic may not be an indicator of elevated risk. However, a vehicle travelling at the same speed and same frequency of lane changes but at a higher traffic density may be indicative of a higher risk of accident or injury. Likewise, if the driver state indicates a lower level of cognitive ability due to some sensable or measurable factor, then the total sequence of states (speed, driving pattern, cognitive ability) may be indicative of an elevated accident risk.

As can be seen, the risk determination system may take account of driving data related to other road users traveling on the one or more routes identified in operation 204. Thus, if a particular driver or vehicle is assessed as being at an elevated risk of an accident, the risk determination system may forecast an elevated level of risk for the route that particular driver or vehicle is on. In addition, driving data related to other road users traveling on the one or more routes may indicate an elevated level of risk for that route due to factors that are not created by that driver, but rather, that cause the driver to react (e.g., a recently formed hazard not yet stored in the environmental data sources that causes the driver to swerve, slam on the brakes, etc.).

The forecasted risk determined in operation 206 may be determined at the semi-autonomous vehicle 120, or may be determined at a remote location and transmitted to the semi-autonomous vehicle 120. For example, in an exemplary embodiment, the semi-autonomous vehicle 120 may receive data used to determine the forecasted risk via the communications system 132, and the onboard computer system 128 may determine the forecasted risk using the received data. In an exemplary embodiment, the forecasted risk may be determined by a computer system (e.g., the server computer 160) located remotely from the semi-autonomous vehicle 120 and then transmitted to the semi-autonomous vehicle 120 via the communications system 132.

In operation 208, one of the one or more routes identified in operation 204 is selected to be used by the semi-autonomous vehicle 120 to travel from the current location to the target destination. Selection of the one or more routes may be based on various factors including, for example, the forecasted risk determined in operation 206, the estimated time that each route will take, the distance of each route, current traffic conditions of each route, speed limits of different roads included on each route, etc. The selected route may be selected automatically by the semi-autonomous vehicle 120 or manually by the driver or a passenger.

For example, in an exemplary embodiment, once the one or more routes have been determined in operation 204, the semi-autonomous vehicle 120 may present the routes, for example, via the user interface 126, to a user (e.g., the driver or a passenger) to allow the user to select one of the routes. The user interface 126 may provide the user with different characteristics corresponding to each route to assist the user in selecting one of the routes. For example, for each route, the user interface 126 may provide the corresponding total time to destination, the corresponding total distance to destination, the corresponding risk as forecasted in operation 206, the corresponding traffic conditions, the corresponding weather conditions, etc., allowing the user to select a route based on the user's personal preference.

Alternatively, in an exemplary embodiment, the user may provide a default setting directing the semi-autonomous vehicle 120 to automatically select one of the determined routes without further input from the user. For example, the user may provide a default setting indicating to the semi-autonomous vehicle 120 that the route having the lowest forecasted risk be automatically selected, that the fastest route (time-wise) be automatically selected, that the shorted route (distance-wise) be automatically selected, etc. In an exemplary embodiment, the user may initially provide a default setting indicating the factors to be used by the semi-autonomous vehicle 120 to automatically select a route, and the user may subsequently change the automatically selected route manually.

In operation 210, the semi-autonomous vehicle 120 predicts a latest point in time at which control of the semi-autonomous vehicle 120 should be handed over from the semi-autonomous vehicle 120 to the driver based on the previously determined forecasted risk of the selected route. This latest point in time may be referred to herein as a critical time point. For example, once a route is selected in operation 208, the semi-autonomous vehicle 120 begins autonomously driving itself toward the target destination on the selected route. There may exist one or more high-risk locations corresponding to adverse events along the selected route for which handing over control of the semi-autonomous vehicle 120 from the vehicle 120 to the driver increases the safety of the trip when traveling from the current location to the target destination. For example, in certain high-risk locations corresponding to certain adverse events, it may be safer for the driver to manually drive the semi-autonomous vehicle 120 than for the semi-autonomous vehicle 120 to autonomously drive itself. This high-risk location(s) corresponding to an adverse event(s) is known to the semi-autonomous vehicle 120 via the forecasted risk determination made in operation 206.

By way of example, it may be determined that the selected route includes a high-risk location corresponding to an adverse event at a certain point along the route. Depending on the type of adverse event that caused the high-risk location, a latest point in time (the critical time point) at which control of the semi-autonomous vehicle 120 should be handed over from the semi-autonomous vehicle 120 to the driver may be predicted. For example, a table stored in a database of the onboard computer system 128 in the semi-autonomous vehicle 120 or in a remote database included in the server computer 160 and accessible to the semi-autonomous vehicle 120 via the communications system 132 may indicate the amount of lead time (critical time point lead time) that should be given to the driver when the semi-autonomous vehicle 120 is approaching different types of adverse events. Different types of adverse events may have different lead times (critical time point lead times).

In an example, the type of adverse event existing on the selected route may be icy road conditions, and the table may indicate that a driver should be given a critical time point lead time of 1 minute before reaching the icy road conditions (e.g., the high-risk location corresponding to the adverse event). Thus, if the current time is t, and the semi-autonomous vehicle 120 is estimated to arrive at the icy road conditions at a time t+10 minutes, it may be predicted that the latest point in time (the critical time point) at which control of the semi-autonomous vehicle 120 should be handed over to the driver is at a time t+9 minutes.

The critical time point predicted in operation 210 may be determined at the semi-autonomous vehicle 120, or may be determined at a remote location and transmitted to the semi-autonomous vehicle 120. For example, according to exemplary embodiments, the onboard computer system 128 may determine the critical time point, or the critical time point may be determined by a computer system (e.g., the server computer 160) located remotely from the semi-autonomous vehicle 120 and then transmitted to the semi-autonomous vehicle 120 via the communications system 132.

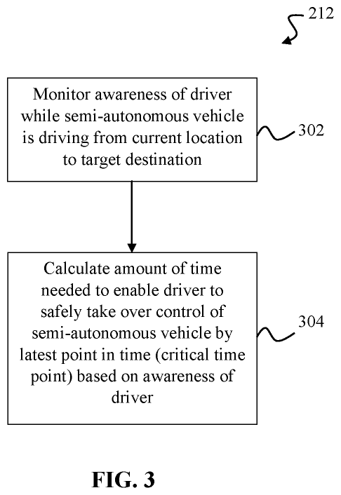

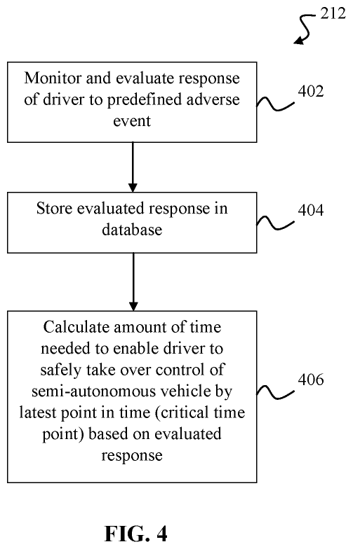

In operation 212, the amount of time needed to enable the driver to safely take over control of the semi-autonomous vehicle 120 by the critical time point predicted in operation 210 is calculated. In exemplary embodiments, the amount of time needed to enable the driver to safely take over control of the semi-autonomous vehicle 120 by the latest point in time (the critical time point) is predicted based on factors relating specifically to the driver. For example, FIGS. 3 and 4, which are described below, illustrate operation 212 according to exemplary embodiments of the present invention.

FIG. 3 is a flowchart illustrating a method of calculating the amount of time needed to enable the driver to safely take over control of the semi-autonomous vehicle by the latest point in time (critical time point) according to an exemplary embodiment of the present invention.

Referring to FIGS. 2 and 3, in an exemplary embodiment, operation 212 illustrated in FIG. 2 includes operations 302 and 304 illustrated in FIG. 3. In operation 302, the awareness of the driver while the semi-autonomous vehicle 120 is driving from the current location to the target destination is monitored. The amount of time needed to enable the driver to safely take over control of the semi-autonomous vehicle 120 by the critical time point is then calculated based on the monitored awareness of the driver in operation 304. More time may be needed when it is determined that the driver is in a low state of awareness compared to when the driver is in a high state of awareness.

For example, in the example described above relating to icy road conditions, the driver's awareness may be monitored. In a first scenario in which it is determined that the driver is in a high state of awareness, it may be calculated that the driver needs only 10 seconds of lead time before the critical time point to enable the driver to safely take over control of the semi-autonomous vehicle 120 by the critical time point. In a second scenario in which it is determined that the driver is in a low state of awareness, it may be calculated that the driver needs 1 minute of lead time before the critical time point to enable the driver to safely take over control of the semi-autonomous vehicle 120 by the critical time point.

The driver's awareness may be monitored in a variety of ways. For example, the camera included in the sensor system 130 may be pointed at the driver and may monitor the state of awareness of the driver. For example, facial recognition and other image monitoring approaches may be used to determine whether the driver is in a high state of awareness (e.g., the driver's head is in an upright position, with his or her eyes attentively looking at the road) or in a low state of awareness (e.g., the driver's head is slumped over and/or his or her eyes are not attentively looking at the road). In exemplary embodiments, driver sensors worn by the driver may be used to detect conditions of the driver related to awareness such as, for example, the driver's heart rate. Other driver data sensors, worn or otherwise, may also be used to measure or estimate cognitive function, emotional states, etc.

FIG. 4 is a flowchart illustrating a method of calculating the amount of time needed to enable the driver to safely take over control of the semi-autonomous vehicle by the latest point in time (critical time point) according to an exemplary embodiment of the present invention.

Referring to FIGS. 2 and 4, in an exemplary embodiment, operation 212 illustrated in FIG. 2 includes operations 402, 404 and 406 illustrated in FIG. 4. In operation 402, the driver's past responses to different types of adverse events are monitored and evaluated. In operation 404, these evaluated responses are stored in a database (e.g., a database of the onboard computer system 128 in the semi-autonomous vehicle 120 or a remote database included in the server computer 160 and accessible to the semi-autonomous vehicle 120 via the communications system 132). These stored evaluated responses may later be referred to when the driver is approaching a certain type of adverse event to determine how the driver typically responds to that type of adverse event. For example, the amount of time needed to enable the driver to safely take over control of the semi-autonomous vehicle 120 by the critical time point is calculated based on these stored evaluated responses in operation 406.

In the example described above relating to icy road conditions, previous driver evaluations may indicate that the driver typically responds slowly and/or has a difficult time navigating icy roads. Based on this information, additional lead time may be added before the critical time point to enable the driver to prepare to safely take over control of the semi-autonomous vehicle by the critical time point. For example, previous experiences driving on icy roads may cause the driver to feel nervous and uncomfortable when icy roads are upcoming on the selected route, and additional lead time may help the driver prepare to drive in these conditions. In another example, if the upcoming adverse event corresponds to roadwork, and previous driver evaluations indicate that the driver is slow to respond to roadwork when driving, additional lead time may be provided to the driver.

Evaluating the response of the driver to certain types of adverse events may be performed using, for example, the camera included in the sensor system 130 and/or driver data sensors, worn or otherwise, that measure or estimate cognitive function, emotional states, etc. In addition, the driver's interaction with the control system 124 of the semi-autonomous vehicle 120 (e.g., the driver's use of the steering unit, the throttle, the brake unit, etc.), and the effect of the driver's driving style on the propulsion system 122 of the semi-autonomous vehicle 120 may be used when evaluating the response of the driver to certain types of adverse events.

The evaluated responses may be obtained prior to the semi-autonomous vehicle 120 receiving the target destination. Thus, when the time comes that the driver or a passenger provides a target destination, evaluated responses of the driver to different types of adverse events that may occur on the current trip are already known, stored and accessible.

Predefined adverse events, for which the driver's response is evaluated and stored, may include, for example, the driver's response when the semi-autonomous vehicle 120 is approaching an intersection, a highway on-ramp, a highway off-ramp, an accident scene, a weather hazard, roadwork, an object on a road, a point at which the driver's input regarding navigation decisions is needed, etc.

The amount of time calculated in operation 212 may be calculated at the semi-autonomous vehicle 120, or may be calculated at a remote location and transmitted to the semi-autonomous vehicle 120. For example, according to exemplary embodiments, the onboard computer system 128 may calculate the amount of time, or the amount of time may be calculated by a computer system (e.g., the server computer 160) located remotely from the semi-autonomous vehicle 120 and then transmitted to the semi-autonomous vehicle 120 via the communications system 132.

Referring again to FIG. 2, in operation 214, a handover time at which control of the semi-autonomous vehicle 120 is to be handed off from the semi-autonomous vehicle 120 to the driver is calculated. This calculation is based on the critical time point predicted in operation 210 and the calculation made in operation 212. That is, this predication is based on the predicted latest point in time (critical time point) at which control of the semi-autonomous vehicle 120 should be handed over to the driver based on forecasted risk as predicted in operation 210 and the amount of time calculated as being needed to enable the driver to safely take over control of the semi-autonomous vehicle 120 by the critical time point as calculated in operation 212.

For example, referring again to the example described above in which the type of adverse event existing on the selected route is icy road conditions, assume that the current time is t and that the latest point in time (the critical time point) at which control of the semi-autonomous vehicle 120 should be handed over to the driver is predicted to be a time t+9 minutes (operation 210). Further assume that in operation 212, it is determined that the driver is in a low state of awareness, and thus, the driver needs 1 minute of lead time before the critical time point to enable the driver to safely take over control of the semi-autonomous vehicle 120 by the critical time point. In this scenario, the handover time is calculated to be a time t+8 minutes. This amount of time gives the driver the calculated 1 minute of lead time allowing the driver to be prepared to take over control of the semi-autonomous vehicle at the critical time point of t+9 minutes.

The handover time calculated in operation 214 may be calculated at the semi-autonomous vehicle 120, or may be calculated at a remote location and transmitted to the semi-autonomous vehicle 120. For example, according to exemplary embodiments, the onboard computer system 128 may calculate the handover time, or the handover time may be calculated by a computer system (e.g., the server computer 160) located remotely from the semi-autonomous vehicle 120 and then transmitted to the semi-autonomous vehicle 120 via the communications system 132.

In operation 216, a takeover alert is provided to the driver at the handover time, alerting the driver that it is time to take over control of the semi-autonomous vehicle 120 (e.g., alerting the driver that it is time to manually drive the semi-autonomous vehicle 120). The takeover alert may be provided by the alert system included in the user interface 126 of the semi-autonomous vehicle 120. The takeover alert may be, for example, a discernable alarm, such as a light or sound. The takeover alert may include an audible description of the upcoming adverse event, allowing the driver to further prepare for encountering the adverse event. The takeover alert may be transmitted via a device installed in the semi-autonomous vehicle 120, such as a display or speakers. In addition, the takeover alert may be transmitted from the alert system to a device worn by the driver. For example, the takeover alert may be a vibration that occurs on a device worn by the driver, such as a smartwatch, that is transmitted from the alert system to the worn device.

Once the driver responds to the takeover alert by taking over control of the semi-autonomous vehicle 120, the semi-autonomous vehicle 120 transitions from a self-driving (autonomous) mode in which the vehicle 120 drives itself to a non-self-driving mode in which the vehicle 120 is driven by the driver.

In exemplary embodiments, if the driver does not respond to the takeover alert in a timely manner, the semi-autonomous vehicle 120 may be autonomously safely stopped (e.g., pulled over to the side of the road) if the driver does not take over control from the semi-autonomous vehicle 120 within a predetermined amount of time that elapses after the handover time. For example, if the driver does not respond to the takeover alert within the predetermined amount of time, the semi-autonomous vehicle 120 may safely stop itself before the adverse event is reached for safety reasons.

In exemplary embodiments, operation 208 may include identifying one of the one or more routes that has a lowest driver involvement time. For example, in operation 208, the route that will require the least amount of intervention from the driver may be automatically selected. Alternatively, the driver may manually select such a route rather than having the semi-autonomous vehicle 120 automatically make this selection. Thus, even though route A may take a longer time than route B, the driver may select route A if route A does not require the driver to manually drive the semi-autonomous vehicle 120, but route B requires the driver to take over control of the semi-autonomous vehicle 120.

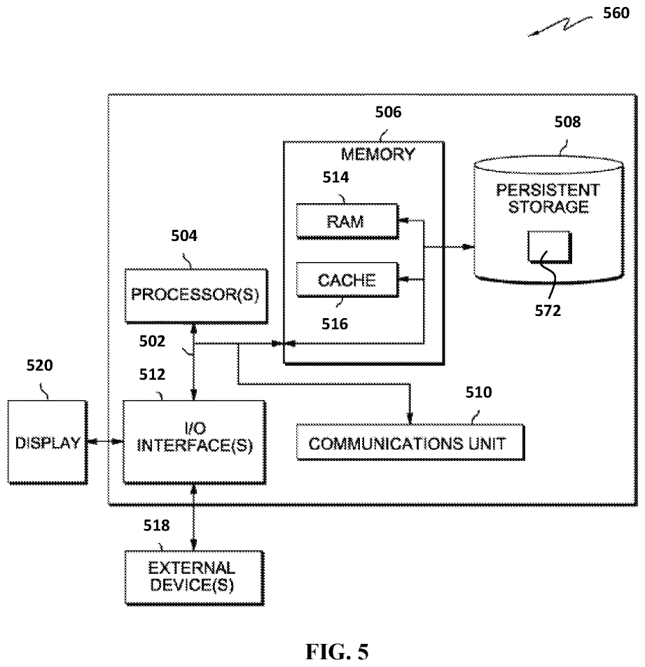

FIG. 5 is a block diagram of a computer system that may be used to implement various aspects of exemplary embodiments of the present invention. For example, the computer system may be used to implement aspects of the semi-autonomous vehicle 120 and/or the server computer 160 illustrated in FIG. 1.

A computer system 560 includes a data bus 502, which provides communications between computer processor(s) 504, a memory 506, a persistent storage 508, a communications unit 510, and an input/output (I/O) interface(s) 512. The data bus 502 can be implemented with any architecture designed for passing data and/or control information between processors (such as microprocessors, communications and network processors, etc.), system memory, peripheral devices, and any other hardware components within a system.

The memory 506 and the persistent storage 508 (also referred to as a database) are computer-readable storage media. In this exemplary embodiment, the memory 506 includes random access memory (RAM) 514 and cache memory 516. In general, the memory 506 can include any suitable volatile or non-volatile computer-readable storage media.

Program instructions 572 (e.g., a computer program) are stored in the persistent storage 508 for execution by one or more of the respective computer processors 504 via one or more memories of the memory 506. The persistent storage 508 may include, for example, a magnetic hard disk drive, a solid state hard drive, a semiconductor storage device, read-only memory (ROM), erasable programmable read-only memory (EPROM), flash memory, or any other computer-readable storage media that is capable of storing program instructions or digital information.

The media used by the persistent storage 508 may also be removable. For example, a removable hard drive may be used for the persistent storage 508. Other examples include optical and magnetic disks, thumb drives, and smart cards that are inserted into a drive for transfer onto another computer-readable storage medium that is also part of the persistent storage 508.

The communications unit 510, in these examples, provides for communications with other data processing systems or devices. In these examples, the communications unit 510 includes one or more network interface cards. The communications unit 510 may provide communications through the use of either or both physical and wireless communications links. Program instructions 572 may be downloaded to the persistent storage 508 through the communications unit 510.

The I/O interface(s) 512 allows for input and output of data with other devices that may be connected to the computer system 560. For example, the I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice exemplary embodiments of the present invention can be stored on such portable computer-readable storage media and can be loaded onto the persistent storage 508 via I/O interface(s) 512. The I/O interface(s) 512 may also connect to a display 520.

The display 520 provides a mechanism to display data to a user and may be, for example, a computer monitor or a display of a touchscreen input device.

The flowchart and block diagrams in the figures illustrate the architecture, functionality, and operation of possible implementations of systems, methods and computer program products according to various exemplary embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. For example, the computer readable storage medium may be a non-transitory computer readable storage medium.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In exemplary embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to exemplary embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

While the present invention has been particularly shown and described with reference to the exemplary embodiments thereof, it will be understood by those of ordinary skill in the art that various changes in form and detail may be made therein without departing from the spirit and scope of the present invention as defined by the following claims.

What is claimed is:

1. A method of operating a semi-autonomous vehicle, comprising:
receiving a target destination of the semi-autonomous vehicle;
determining, by at least one processor, one or more routes from a current location of the semi-autonomous vehicle to the target destination;
determining, by the at least one processor, a forecasted risk associated with each of the one or more routes;
predicting, by the at least one processor, a latest point in time at which control of the semi-autonomous vehicle should be handed over from the semi-autonomous vehicle to a driver of the semi-autonomous vehicle based on the forecasted risk;
calculating, by the at least one processor, an amount of time needed to enable the driver to safely take over control of the semi-autonomous vehicle by the latest point in time;
calculating, by the at least one processor, a handover time at which control of the semi-autonomous vehicle is to be handed off from the semi-autonomous vehicle to the driver based on the latest point in time and the calculated amount of time; and
providing a takeover alert to the driver at the handover time indicating that the driver should take over control of the semi-autonomous vehicle.

2. The method of claim 1, wherein calculating the amount of time needed to enable the driver to safely take over control of the semi-autonomous vehicle by the latest point in time comprises:
monitoring an awareness of the driver while the semi-autonomous vehicle is driving from the current location to the target destination,
wherein the amount of time needed to enable the driver to safely take over control of the semi-autonomous vehicle by the latest point in time is based on the awareness of the driver.

3. The method of claim 1, wherein calculating the amount of time needed to enable the driver to safely take over control of the semi-autonomous vehicle by the latest point in time comprises:
evaluating a response of the driver to a predefined adverse event; and
storing the evaluated response in a database,
wherein the amount of time needed to enable the driver to safely take over control of the semi-autonomous vehicle by the latest point in time is based on the evaluated response.

4. The method of claim 3, wherein evaluating the response of the driver is performed prior to receiving the target destination.

5. The method of claim 3, wherein the predefined adverse event comprises the semi-autonomous vehicle approaching at least one of an intersection, a highway on-ramp, a highway off-ramp, an accident scene, a weather hazard, and an object on a road.

6. The method of claim 1, further comprising:
autonomously safely stopping the semi-autonomous vehicle without intervention of the driver when the driver fails to take control of the semi-autonomous vehicle within a predetermined amount of time that elapses after the handover time.

7. The method of claim 1, further comprising:
identifying one of the one or more routes that has a lowest driver involvement time based on at least one of the forecasted risk, the calculated amount of time and the handover time; and
selecting the identified route, wherein the semi-autonomous vehicle uses the selected route to travel from the current location to the target destination.

8. A semi-autonomous vehicle system, comprising:
a memory storing a computer program; and
a processor that executes the computer program, wherein the computer program is configured to:
receive a target destination of a semi-autonomous vehicle;
determine one or more routes from a current location of the semi-autonomous vehicle to the target destination;
determine a forecasted risk associated with each of the one or more routes;
predict a latest point in time at which control of the semi-autonomous vehicle should be handed over from the semi-autonomous vehicle to a driver of the semi-autonomous vehicle based on the forecasted risk;
calculate an amount of time needed to enable the driver to safely take over control of the semi-autonomous vehicle by the latest point in time;
calculate a handover time at which control of the semi-autonomous vehicle is to be handed off from the semi-autonomous vehicle to the driver based on the latest point in time and the calculated amount of time; and
provide a takeover alert to the driver at the handover time indicating that the driver should take over control of the semi-autonomous vehicle.

9. The semi-autonomous vehicle system of claim 8, further comprising:
a camera disposed in the semi-autonomous vehicle,
wherein the computer program is further configured to:
monitor an awareness of the driver, using the camera, while the semi-autonomous vehicle is driving from the current location to the target destination,
wherein the amount of time needed to enable the driver to safely take over control of the semi-autonomous vehicle by the latest point in time is based on the awareness of the driver.

10. The semi-autonomous vehicle system of claim 8, wherein the computer program is further configured to:
evaluate a response of the driver to a predefined adverse event; and
store the evaluated response in a database,
wherein the amount of time needed to enable the driver to safely take over control of the semi-autonomous vehicle by the latest point in time is based on the evaluated response.

11. The semi-autonomous vehicle system of claim 10, wherein evaluating the response of the driver is performed prior to receiving the target destination.

12. The semi-autonomous vehicle system of claim 10, wherein the predefined adverse event comprises the semi-autonomous vehicle approaching at least one of an intersection, a highway on-ramp, a highway off-ramp, an accident scene, a weather hazard, and an object on a road.

13. The semi-autonomous vehicle system of claim 8, wherein the computer program is further configured to:
autonomously safely stop the semi-autonomous vehicle without intervention of the driver when the driver fails to take control of the semi-autonomous vehicle within a predetermined amount of time that elapses after the handover time.

14. The semi-autonomous vehicle system of claim 8, wherein the computer program is further configured to:
identify one of the one or more routes that has a lowest driver involvement time based on at least one of the forecasted risk, the calculated amount of time and the handover time; and
select the identified route, wherein the semi-autonomous vehicle uses the selected route to travel from the current location to the target destination.

15. A computer program product comprising a computer readable storage medium having program instructions embodied therewith, the program instructions executable by a processor to cause the processor to:
receive a target destination of a semi-autonomous vehicle;
determine one or more routes from a current location of the semi-autonomous vehicle to the target destination;
determine a forecasted risk associated with each of the one or more routes;
predict a latest point in time at which control of the semi-autonomous vehicle should be handed over from the semi-autonomous vehicle to a driver of the semi-autonomous vehicle based on the forecasted risk;
calculate an amount of time needed to enable the driver to safely take over control of the semi-autonomous vehicle by the latest point in time;
calculate a handover time at which control of the semi-autonomous vehicle is to be handed off from the semi-autonomous vehicle to the driver based on the latest point in time and the calculated amount of time; and
provide a takeover alert to the driver at the handover time indicating that the driver should take over control of the semi-autonomous vehicle.

16. The computer program product of claim 15, wherein the program instructions further cause the processor to:
monitor an awareness of the driver while the semi-autonomous vehicle is driving from the current location to the target destination,
wherein the amount of time needed to enable the driver to safely take over control of the semi-autonomous vehicle by the latest point in time is based on the awareness of the driver

17. The computer program product of claim 15, wherein the program instructions further cause the processor to:
evaluate a response of the driver to a predefined adverse event; and
store the evaluated response in a database,
wherein the amount of time needed to enable the driver to safely take over control of the semi-autonomous vehicle by the latest point in time is based on the evaluated response.

18. The computer program product of claim 17, wherein evaluating the response of the driver is performed prior to receiving the target destination.

19. The computer program product of claim 17, wherein the predefined adverse event comprises the semi-autonomous vehicle approaching at least one of an intersection, a highway on-ramp, a highway off-ramp, an accident scene, a weather hazard, and an object on a road.

20. The computer program product of claim 15, wherein the program instructions further cause the processor to:
autonomously safely stop the semi-autonomous vehicle without intervention of the driver when the driver fails to take control of the semi-autonomous vehicle within a predetermined amount of time that elapses after the handover time.
